(19) United States
(12) Patent Application Publication
(10) Pub. No.: US 2026/0251408 A1
(43) Pub. Date: Aug. 27, 2026

(54) HEAT EXCHANGE DEVICE AND HEAT EXCHANGE UNIT

(71) Applicants: TOYODA GOSEI CO., LTD., Kiyosu-shi (JP); TOYOTA JIDOSHA KABUSHIKI KAISHA, Toyota-shi (JP)

(72) Inventors: Kenta KUWAYAMA, Kiyosu-shi (JP); Shintaro UTSUMI, Susono-shi (JP)

(21) Appl. No.: 19/535,233

(22) Filed: Feb. 10, 2026

(30) Foreign Application Priority Data
Feb. 21, 2025 (JP) 2025-027357

(51) Int. Cl. F28F 9/26; F28D 21/00; F28F 9/02

(52) U.S. Cl. CPC F28F 9/26; F28D 21/00; F28F 9/02; F28D 2021/008; F28F 2275/14

(57) ABSTRACT

In a heat exchange device 1 including an assembly base 3 and a heat exchange unit 2 assembled to the assembly base 3, the heat exchange unit 2 includes: a first heat exchanger 4 including a first heat exchange body 40, a first port portion 41, and a first pipe 42 and assembled to the assembly base 3;and a second heat exchanger 5 including a second heat exchange body 50, a second port portion 51, and a second pipe 52 and assembled to the first heat exchanger 4, and when the first and second port portions 41 and 51 are assembled together, the first heat exchanger 4 and the second heat exchanger 5 are integrated, and a first heat exchange flow path 40f of the first heat exchange body 40 and a second heat exchange flow path 50f of the second heat exchange body 50 communicate with each other.

### TECHNICAL FIELD

The present disclosure relates to a heat exchange unit in which a plurality of heat exchangers are integrated, and a heat exchange device including the heat exchange unit.

### BACKGROUND ART

Heat exchangers for cooling or heating an object have been conventionally known.

A typical heat exchanger cools or heats the object by directly or indirectly exchanging heat between the object and a fluid heat exchange medium circulating through the heat exchanger.

A heat exchange unit in which the above heat exchangers are integrated is also known (see, for example, Chinese Patent Application Publication No. 116914322 (CN116914322A)).

The heat exchange unit is used, for example, when a plurality of objects are arranged, and the heat exchangers of the heat exchange unit are arranged alternately with the objects.

### SUMMARY OF INVENTION

### Technical Problem

As described above, a heat exchanger performs heat exchange with an object using a fluid heat exchange medium. Accordingly, in the above heat exchange unit, each heat exchanger is provided with a flow path, and the heat exchange medium circulates through the flow path.

In this type of heat exchange unit, the flow path for the heat exchange medium in each heat exchanger may be independent of one another. However, in consideration of simplification and downsizing of the structure of the heat exchange unit, the flow paths in the respective heat exchangers communicating with each other is preferable. This is because, if the flow paths in the respective heat exchangers communicate with each other, a pump, a liquid tank, etc., for circulating the heat exchange medium are shared among the heat exchangers.

For example, CN116914322A discloses that a plurality of heat exchangers 12 integrated with each other each have individual flow paths 22 and 36 and these flow paths 22 and 36 in each heat exchanger 12 are connected to each other via ports 28 and 30 and a flow path 20 formed in a shared heat exchanger 10.

Here, in the heat exchange unit disclosed in CN116914322A, the plurality of heat exchangers 12 are integrated by welding each heat exchanger 12 to a base plate 48 of the heat exchanger 10. However, a relatively large working space is required in order to perform such integration work.

Therefore, a connection structure as in the above-described heat exchange unit disclosed in CN116914322A is not suitable for, for example, a heat exchange unit for which the work of integrating a plurality of heat exchangers needs to be performed in a small working space, such as a heat exchange unit in which a plurality of heat exchangers are arranged inside an assembly base having a box shape and are integrated with the assembly base.

Accordingly, there has been a need for a technology that does not require a large space for the work of integrating a plurality of heat exchangers in a heat exchange unit including these heat exchangers.

The present disclosure has been made in view of the above circumstances, and an object of the present disclosure is to provide a technology that eliminates the need for a large space for the work of integrating a plurality of heat exchangers included in a heat exchange unit.

### SOLUTION TO PROBLEM

A heat exchange device of the present disclosure for achieving the above object is a heat exchange device including an assembly base and a heat exchange unit assembled to the assembly base, wherein

the heat exchange unit includes:

a first heat exchanger including a first heat exchange body having a first heat exchange flow path, a first port portion having a first communication flow path and integrated with the first heat exchange body, and a first pipe providing communication between the first heat exchange flow path and the first communication flow path, the first heat exchanger being assembled to the assembly base; and

a second heat exchanger including a second heat exchange body having a second heat exchange flow path, a second port portion having a second communication flow path and integrated with the second heat exchange body, and a second pipe providing communication between the second heat exchange flow path and the second communication flow path, the second heat exchanger being assembled to the first heat exchanger, and

when the first port portion and the second port portion are assembled together, the first heat exchanger and the second heat exchanger are integrated, and the first heat exchange flow path and the second heat exchange flow path communicate with each other.

A heat exchange unit of the present disclosure for achieving the above object is a heat exchange unit configured to be assembled to an assembly base, the heat exchange unit including:

a first heat exchanger including a first heat exchange body having a first heat exchange flow path, a first port portion having a first communication flow path and integrated with the first heat exchange body, and a first pipe providing communication between the first heat exchange flow path and the first communication flow path, the first heat exchanger being assembled to the assembly base; and

a second heat exchanger including a second heat exchange body having a second heat exchange flow path, a second port portion having a second communication flow path and integrated with the second heat exchange body, and a second pipe providing communication between the second heat exchange flow path and the second communication flow path, the second heat exchanger being assembled to the first heat exchanger, wherein

when the first port portion and the second port portion are assembled together, the first heat exchanger and the second heat exchanger are integrated, and the first heat exchange flow path and the second heat exchange flow path communicate with each other.

### ADVANTAGEOUS EFFECTS OF INVENTION

According to the heat exchange unit of the present disclosure and the heat exchange device of the present disclosure including the heat exchange unit, the work of integrating the plurality of heat exchangers included in the heat exchange unit does not require a large working space.

### BRIEF DESCRIPTION OF DRAWINGS

FIG. 1 schematically illustrates a heat exchange device of an embodiment;

FIG. 2 schematically illustrates the heat exchange device of the embodiment as seen from the upper side in FIG. 1;

FIG. 3 schematically illustrates the heat exchange device of the embodiment as seen from the rear side in FIG. 1;

FIG. 4 schematically illustrates each of a base-side attachment portion, a first port portion, a first pipe, a second port portion, and a second pipe in the heat exchange device of the embodiment;

FIG. 5 schematically illustrates a state where the base-side attachment portion, the first port portion, the first pipe, the second port portion, and the second pipe in the heat exchange device of the embodiment are assembled to each other;

FIG. 6 schematically illustrates the heat exchange device of the embodiment cut at a position A-A in FIG. 3;

FIG. 7 schematically illustrates the heat exchange device of the embodiment cut at a position B-B in FIG. 3;

FIG. 8 schematically illustrates the heat exchange device of the embodiment cut at a position C-C in FIG. 3;

FIG. 9 schematically illustrates the heat exchange device of the embodiment cut at a position D-D in FIG. 8;

FIG. 10 schematically illustrates the heat exchange device of the embodiment cut at a position E-E in FIG. 3; and

FIG. 11 schematically illustrates the heat exchange device of the embodiment cut at a position F-F in FIG. 10.

### DESCRIPTION OF EMBODIMENTS

The heat exchange device of the present disclosure includes an assembly base and the heat exchange unit of the present disclosure assembled to the assembly base.

The heat exchange unit of the present disclosure includes:

a first heat exchanger including a first heat exchange body having a first heat exchange flow path, a first port portion having a first communication flow path and integrated with the first heat exchange body, and a first pipe providing communication between the first heat exchange flow path and the first communication flow path, the first heat exchanger being assembled to the assembly base; and

a second heat exchanger including a second heat exchange body having a second heat exchange flow path, a second port portion having a second communication flow path and integrated with the second heat exchange body, and a second pipe providing communication between the second heat exchange flow path and the second communication flow path, the second heat exchanger being assembled to the first heat exchanger.

In the heat exchange device of the present disclosure and the heat exchange unit of the present disclosure, when the first port portion and the second port portion are assembled together, the first heat exchanger and the second heat exchanger are integrated, and the first heat exchange flow path and the second heat exchange flow path communicate with each other.

In the first heat exchanger, a heat exchange medium flows between the first heat exchange flow path of the first heat exchange body and the first communication flow path of the first port portion through the first pipe. In addition, in the second heat exchanger, the heat exchange medium flows between the second heat exchange flow path of the second heat exchange body and the second communication flow path of the second port portion through the second pipe. Since the first communication flow path and the second communication flow path communicate with each other when the first port portion and the second port portion are assembled together, the heat exchange medium further flows between the first communication flow path and the second communication flow path.

That is, in the heat exchange device of the present disclosure and the heat exchange unit of the present disclosure, the flow path for the heat exchange medium provides communication between the first heat exchanger and the second heat exchanger.

In such a heat exchange device of the present disclosure and such a heat exchange unit of the present disclosure, when the first heat exchanger is assembled to the assembly base and further, the second heat exchanger is assembled to the first heat exchanger, the first heat exchanger and the second heat exchanger are integrated, and moreover, the first heat exchanger and the second heat exchanger are also integrated with the assembly base.

Furthermore, at this time, the first port portion and the second port portion are assembled together, and the first heat exchange flow path and the second heat exchange flow path communicate with each other. Accordingly, as described above, a flow path, for the heat exchange medium, that provides communication between the first heat exchanger and the second heat exchanger is formed.

As described above, in the heat exchange device of the present disclosure and the heat exchange unit of the present disclosure, by simply sequentially assembling the first heat exchanger and the second heat exchanger to the assembly base, a flow path, for the heat exchange medium, that provides communication between the heat exchangers is formed. Thus, the work of integrating a plurality of heat exchangers does not require a large working space, and this work is allowed to be performed in a relatively small space.

Moreover, since the first heat exchange flow path and the second heat exchange flow path are caused to communicate with each other through such a simple assembly process, even when the assembly work for each heat exchanger is performed by, for example, a robot, this assembly work is allowed to be performed with sufficient assembly accuracy.

Hereinafter, the heat exchange unit of the present disclosure will be described for each component thereof.

Unless otherwise specified, a numerical range "x to y" described in this specification includes a lower limit x and an upper limit y. Such an upper limit value and a lower limit value, and values described in an embodiment, may be arbitrarily combined to form a numerical range. Further, any values selected from such a numerical range may be used as an upper limit value and a lower limit value.

The heat exchange unit of the present disclosure cools or heats an object by heat exchange, and the type, shape, etc., of the object are not particularly limited. For example, the object may be a battery cell as disclosed in CN116914322A.

The heat exchange unit of the present disclosure includes an assembly base, a first heat exchanger, and a second heat exchanger.

As for the assembly base, the material and shape thereof are not particularly limited and may be set as appropriate according to the shape and application of the object, etc.

For example, the assembly base may have a box shape. In this case, the first heat exchanger and the second heat exchanger may be housed in the internal space of the assembly base having a box shape. Furthermore, in this case, a part or the entirety of each of the first heat exchanger and the second heat exchanger may be isolated from the external environment.

Alternatively, for example, the assembly base may have a frame shape, a plate shape, a column shape, or the like, and at least a part of each of the first heat exchanger and the second heat exchanger may be exposed to the external environment.

The first heat exchanger includes a first heat exchange body, a first port portion, and a first pipe.

The first heat exchange body has a first heat exchange flow path and is considered as a portion of the heat exchange unit that directly exchanges heat with the object.

Such a first heat exchange body may, for example, have a straight tubular shape or a curved or bent tubular shape. Alternatively, the first heat exchange body may, for example, have a plate shape or a box shape with the first heat exchange passage formed therein.

The first heat exchange flow path may consist of a single flow path or may include a plurality of flow paths. In the case where the first heat exchange flow path includes a plurality of flow paths, the respective flow paths may be independent or may be branched paths communicating with each other.

The material of the first heat exchange body only needs to be a material capable of exchanging heat with the object and having durability against the heat exchange medium, and an appropriate material may be selected according to the use environment of the first heat exchange body, etc.

For example, the material of the first heat exchange body may be a material having excellent thermal conductivity, such as aluminum or other metals and alloys. Alternatively, the material of the first heat exchange body may be a material having excellent electrical insulation properties, such as polyester, polyethylene, and polyamide.

The first heat exchange body may have a single-layer structure or a multilayer structure.

For example, when the first heat exchange body has a plate shape, the first heat exchange body may have a structure in which two sheets are stacked.

In this case, preferably, one of two parts into which the first heat exchange flow path is divided in the axial direction thereof is formed on one sheet, and the other of the parts into which the first heat exchange flow path is divided in the axial direction thereof is formed on the other sheet. Preferably, by stacking and joining these two sheets, the first heat exchange flow path is formed between the two sheets.

Furthermore, in this case, the method of joining the two stacked sheets as described above is not particularly limited, and an appropriate method may be selected from among general methods such as welding, fusion bonding, and adhesion according to the material and shape of the sheets, the use environment of the heat exchange device or heat exchange unit of the present disclosure, etc.

The first port portion is a portion that is integrated with the first heat exchange body described above. The first port portion may be joined and integrated with the first heat exchange body by a method such as welding, fusion bonding, or adhesion or may be molded integrally with the first heat exchange body.

As described above, the first port portion has the first communication flow path. The first communication flow path communicates with the first pipe and communicates with the first heat exchange flow path of the first heat exchange body via the first pipe. Therefore, the number of first communication flow paths only needs to be set as appropriate according to the number of first heat exchange flow paths to which the first communication flow paths are connected.

The material of the first port portion is not particularly limited and may be the same as or different from the material of the first heat exchange body.

The shape of the first port portion is also not particularly limited and may be any of various shapes such as a tubular shape, a plate shape, and a box shape.

The first pipe only needs to connect the first heat exchange flow path provided in the first heat exchange body with the first communication flow path provided in the first port portion. The number of first pipes also only needs to be set as appropriate according to the number of first communication flow paths and the number of first heat exchange flow paths to which the first pipes are connected.

The first pipe may be deformable or non-deformable. However, in consideration of the ease of assembling the first pipe to the first communication flow path and the first heat exchange flow path, the first pipe is preferably deformable and flexible.

Specifically, the first pipe is preferably a bellows pipe, that is, a deformable pipe having a corrugated structure.

The material of the first pipe only needs to be selected as appropriate according to the type of heat exchange fluid and the use environment of the heat exchange device and the heat exchange unit of the present disclosure.

The first pipe itself is not a portion that mainly performs heat exchange with the object in the heat exchange device and the heat exchange unit of the present disclosure. Therefore, a material having excellent thermal conductivity does not have to be selected as the material of the first pipe.

Accordingly, selecting a resin material, such as polyester, polyethylene, and polyamide, as the material of such a first pipe is considered to be particularly preferable.

The second heat exchanger includes a second heat exchange body, a second port portion, and a second pipe.

The second heat exchange body has a second heat exchange flow path and is considered as a portion, of the the heat exchange unit, that directly exchanges heat with the object, similar to the first heat exchange body.

Such a second heat exchange body may have any of various shapes, similar to the first heat exchange body. The shape of the second heat exchange body may be the same as or different from that of the first heat exchange body.

As for the material of the second heat exchange body, similar to the first heat exchange body, an appropriate material may be selected from among various materials. The material of the second heat exchange body may be the same as or different from that of the first heat exchange body.

Similar to the first heat exchange flow path, the second heat exchange flow path may consist of a single flow path or may include a plurality of flow paths. In the case where the second heat exchange flow path includes a plurality of flow paths, the respective flow paths may be independent or may be branched paths communicating with each other.

The second port portion is a portion that is integrated with the second heat exchange body described above. Similar to the first port portion, the second port portion may be joined and integrated with the second heat exchange body by a method such as welding, fusion bonding, or adhesion or may be molded integrally with the second heat exchange body.

As for the shape and material of the second port portion, various shapes and materials may be selected, similar to the first port portion. The second communication flow path provided in the second port portion may also take any of various forms, similar to the first communication flow path provided in the first port portion. The number of second communication flow paths only needs to be set as appropriate according to the number of second heat exchange flow paths to which the second communication flow paths are connected.

The second pipe only needs to connect the second heat exchange flow path provided in the second heat exchange body with the second communication flow path provided in the second port portion. The number of second pipes also only needs to be set as appropriate according to the number of second communication flow paths and the number of second heat exchange flow paths to which the second pipes are connected.

The second pipe may also be deformable or non-deformable but is preferably deformable and flexible. The second pipe is also preferably a bellows pipe.

The material of the second pipe only needs to be set as appropriate in the same manner as the material of the first pipe, and selecting a resin material is particularly preferable.

In the heat exchange device and the heat exchange unit of the present disclosure, as described above, the first heat exchange flow path and the second heat exchange flow path may each include a plurality of independent flow paths.

In this case, any one of the flow paths included in the first heat exchange flow path and any one of the flow paths included in the second heat exchange flow path only need to communicate with each other. The timing at which these flow paths communicate with each other only needs to be the timing at which the first heat exchange flow path and the second heat exchange flow path communicate with each other, that is, the timing at which the second port portion of the second heat exchanger is assembled to the first port portion of the first heat exchanger.

Specifically, for example, the first heat exchange flow path may include a first main flow path and a first sub flow path independent of the first main flow path, and the second heat exchange flow path may include a second main flow path and a second sub flow path independent of the second main flow path. In this case, when the second port portion of the second heat exchanger is assembled to the first port portion of the first heat exchanger, and the first heat exchange flow path and the second heat exchange flow path communicate with each other, the first main flow path of the first heat exchange flow path and the second main flow path of the second heat exchange flow path may communicate with each other, and the first sub flow path of the first heat exchange flow path and the second sub flow path of the second heat exchange flow path may communicate with each other.

The same applies to the case where the first heat exchange flow path and the second heat exchange flow path each include three or more independent flow paths.

In the heat exchange device and the heat exchange unit of the present disclosure, the assembly base and the first heat exchanger preferably have a positioning structure for positioning each other. Similarly, the first heat exchanger and the second heat exchanger preferably have a positioning structure for positioning each other.

Furthermore, the positioning structure of the assembly base and the first heat exchanger preferably extends in an assembly direction of the assembly base and the first heat exchanger, and similarly, the positioning structure of the first heat exchanger and the second heat exchanger preferably extends in an assembly direction of the first heat exchanger and the second heat exchanger.

The assembly direction of the assembly base and the first heat exchanger and the assembly direction of the first heat exchanger and the second heat exchanger may be the same or different. However, in consideration of simplification of the work of assembling these components, these assembly directions are more preferably the same.

Moreover, the positioning structure described above is preferably provided to the base-side attachment portion, which is a portion to which the first heat exchanger is assembled, in the assembly base, is preferably provided to the first port portion in the first heat exchanger, and is preferably provided to the second port portion in the second heat exchanger.

More specifically, the assembly base preferably has a projection-shaped or recess-shaped guide portion at the above base-side attachment portion. The guide portion preferably extends in the assembly direction of the first heat exchanger with respect to the assembly base.

The first heat exchanger preferably has a recess-shaped or projection-shaped guide counterpart corresponding to the above guide portion, at the first port portion. The guide counterpart preferably extends in the above assembly direction.

By having such a guide portion and guide counterpart, when the position of the first heat exchanger is changed toward the assembly base in the assembly direction, the guide portion is inserted into the guide counterpart, or the guide counterpart is inserted into the guide portion, and the first heat exchanger is positioned with respect to the assembly base.

The guide portion and the guide counterpart only need to have recess and projection shapes complementary to each other, and, for example, preferably, one of the guide portion and the guide counterpart, having a projection shape, is a guide pin, and the other of the guide portion and the guide counterpart has a groove shape into which the guide pin is inserted.

Meanwhile, when assembling a projection portion of one member with a recess portion of another member, if the projection portion is located on the leading side in the assembly direction, a worker easily recognizes a location where the projection portion and the recess portion are assembled together, compared to the case where the recess portion is located on the leading side in the assembly direction, thereby improving assembly workability.

Accordingly, more preferably, of the guide portion and the guide counterpart described above, the guide portion of the assembly base, which is located on the leading side in the assembly direction, has a projection shape, and the guide counterpart of the first heat exchanger, which is located on the trailing side in the assembly direction, has a recess shape.

Furthermore, in consideration of positioning accuracy between the guide portion and the guide counterpart, more preferably, the guide portion has a tapered shape with an inclined surface, and the guide counterpart has a concave tapered shape (or a mortar-like shape) with an inclined surface corresponding to the guide portion.

The first heat exchanger preferably has a first engagement portion having a projection shape or a recess shape, at the first port portion. The first engagement portion preferably extends in the above assembly direction.

The second heat exchanger preferably has a second engagement portion having a recess shape or a projection shape corresponding to the above first engagement portion, at the second port portion. The second engagement portion also preferably extends in the above assembly direction.

By having such a first engagement portion and second engagement portion, when the position of the second heat exchanger is changed toward the first heat exchanger in the assembly direction, the first engagement portion is inserted into the second engagement portion, or the second engagement portion is inserted into the first engagement portion, and the second heat exchanger is positioned with respect to the first heat exchanger. At this time, the first engagement portion and the second engagement portion are brought into engagement with each other, thereby assembling the first port portion and the second port portion together.

The first engagement portion and the second engagement portion only need to have recess and projection shapes complementary to each other, and the shapes thereof are not particularly limited. However, more preferably, of the first engagement portion and the second engagement portion, the first engagement portion of the first heat exchanger, which is located on the leading side in the assembly direction, has a projection shape, and the second engagement portion of the second heat exchanger, which is located on the trailing side in the assembly direction, has a recess shape.

Furthermore, in consideration of positioning accuracy between the first engagement portion and the second engagement portion, more preferably, the first engagement portion has a tapered shape with an inclined surface, and the second engagement portion has a mortar shape with an inclined surface corresponding to the first engagement portion.

The heat exchange device and the heat exchange unit of the present disclosure may further include a fixing portion for more firmly integrating the assembly base and the first heat exchanger and/or the first heat exchanger and the second heat exchanger.

For example, as a fixing portion for fixing the assembly base and the first heat exchanger to each other, a connection port having a connection flow path from the heat exchange unit of the present disclosure to an external flow path may be used.

Specifically, the connection port may be inserted from the base-side attachment portion toward the first port portion, thereby causing the first heat exchange flow path to communicate with the connection flow path of the connection port.

In this case, when the first heat exchange flow path and the connection flow path of the connection port communicate with each other, the assembly base into which the connection port has been inserted and the first heat exchanger are fixed to each other. Thus, there is an advantage that the assembly process of the heat exchange device and the heat exchange unit of the present disclosure is simplified and the assembly workability is further improved.

Hereinafter, the heat exchange device and the heat exchange unit of the present disclosure will be described by means of a specific example.

### Embodiment

A heat exchange device of an embodiment is intended for cooling and heating an in-vehicle battery and includes a heat exchange unit of the embodiment and an assembly base.

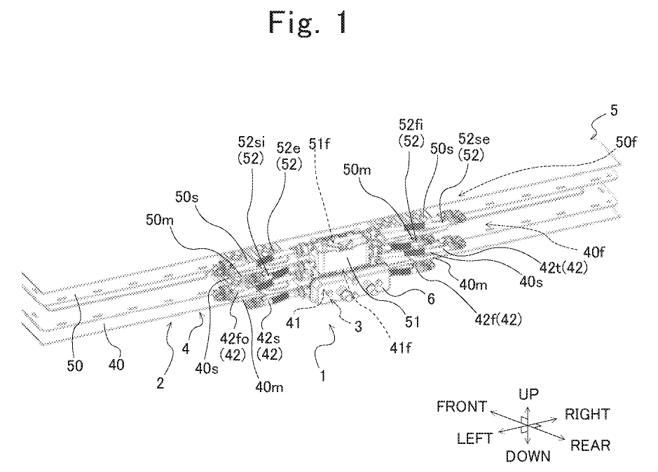

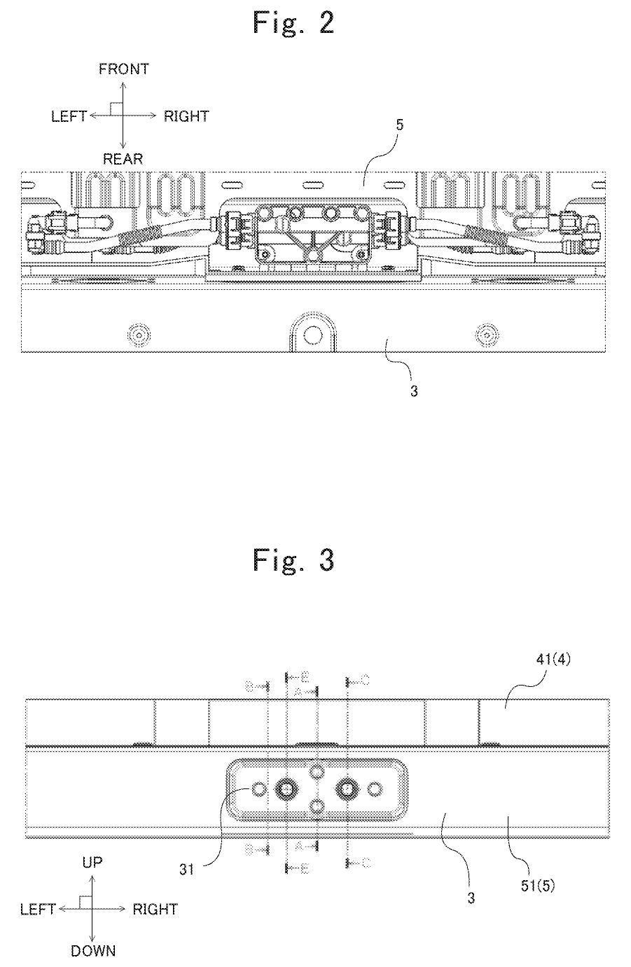

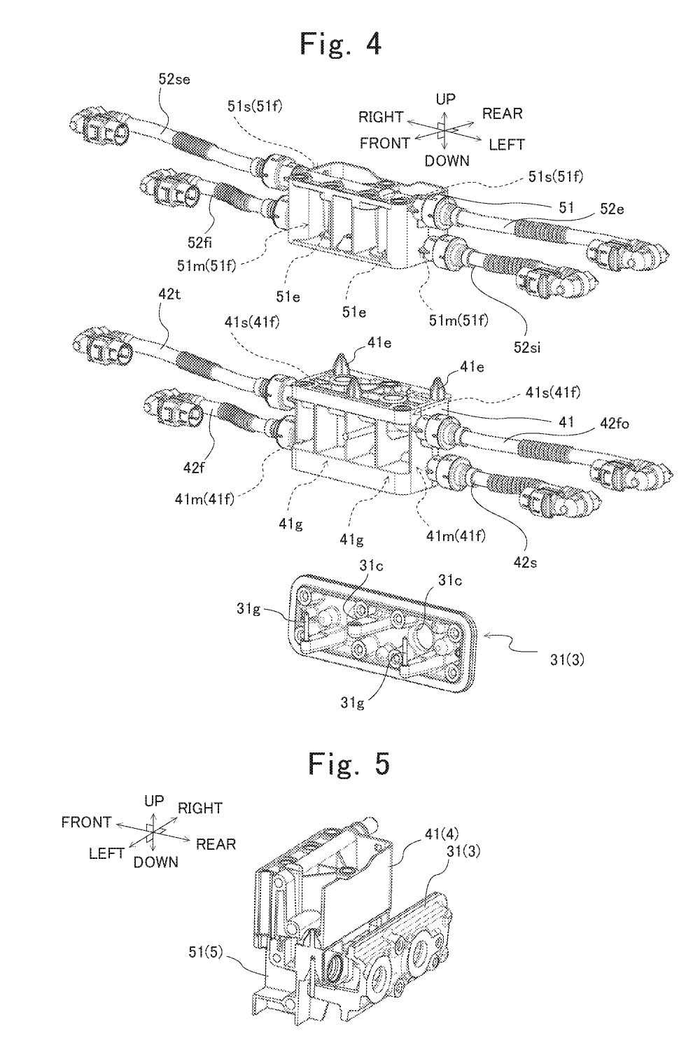

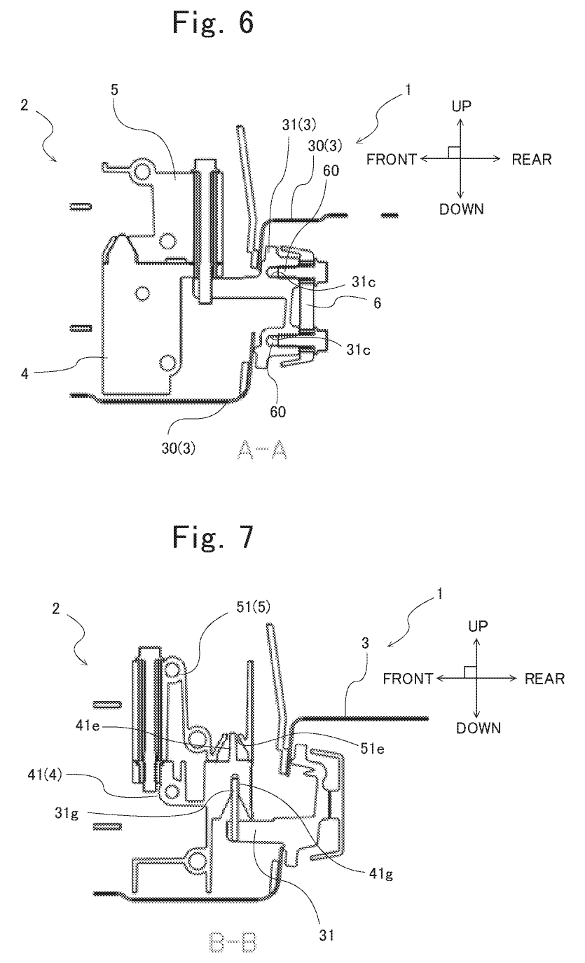

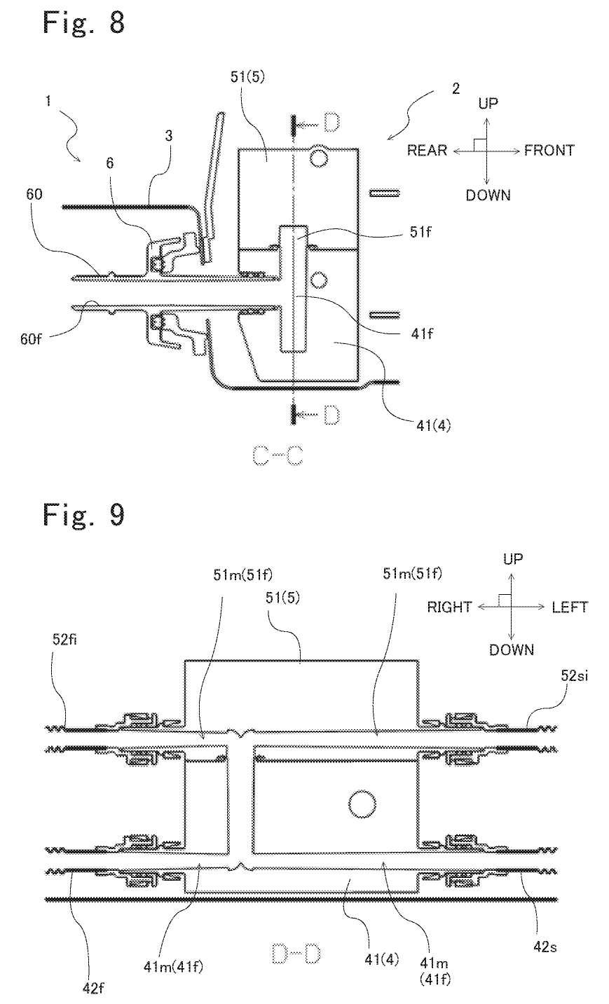

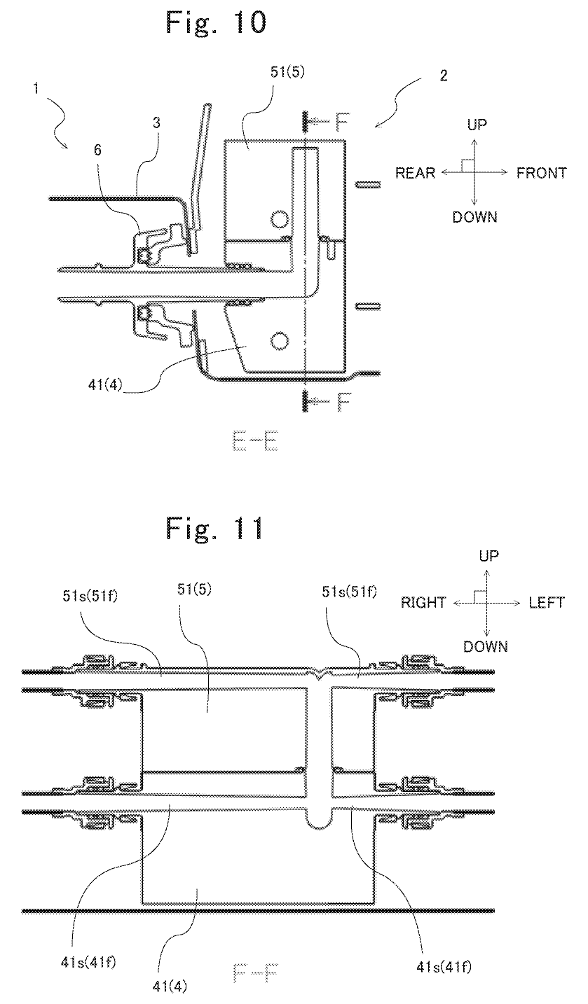

FIG. 1 schematically illustrates a heat exchange device of the embodiment. FIG. 2 schematically illustrates the heat exchange device of the embodiment as seen from the upper side in FIG. 1. FIG. 3 schematically illustrates the heat exchange device of the embodiment as seen from the rear side in FIG. 1. FIG. 4 schematically illustrates each of a base-side attachment portion, a first port portion, a first pipe, a second port portion, and a second pipe in the heat exchange device of the embodiment. FIG. 5 schematically illustrates a state where the base-side attachment portion, the first port portion, the first pipe, the second port portion, and the second pipe in the heat exchange device of the embodiment are assembled to each other. FIG. 6 schematically illustrates the heat exchange device of the embodiment cut at a position A-A in FIG. 3. FIG. 7 schematically illustrates the heat exchange device of the embodiment cut at a position B-B in FIG. 3. FIG. 8 schematically illustrates the heat exchange device of the embodiment cut at a position C-C in FIG. 3. FIG. 9 schematically illustrates the heat exchange device of the embodiment cut at a position D-D in FIG. 8. FIG. 10 schematically illustrates the heat exchange device of the embodiment cut at a position E-E in FIG. 3. FIG. 11 schematically illustrates the heat exchange device of the embodiment cut at a position F-F in FIG. 10.

Hereinafter, in the embodiment, “up”, “down”, “left”, “right”, “front”, and “rear” refer to “up”, “down”, “left”, “right”, “front”, and “rear” in each drawing.

As shown in FIG. 1 to FIG. 3, a heat exchange device 1 of the embodiment includes a heat exchange unit 2 of the embodiment and an assembly base 3.

The heat exchange unit 2 of the embodiment includes a first heat exchanger 4, a second heat exchanger 5, and a connection port 6.

Among these, the first heat exchanger 4 includes a first heat exchange body 40, a first port portion 41, and a first pipe 42.

The first heat exchange body 40 has a plate shape in which two aluminum sheets are stacked and welded to be integrated with each other. A first heat exchange flow path 40f is formed inside the first heat exchange body 40. The first heat exchange flow path 40f includes a first main flow path 40m and a first sub flow path 40s independent of the first main flow path 40m.

The first port portion 41 is made of aluminum, molded separately from the first heat exchange body 40, and welded to the first heat exchange body 40 to be integrated with the first heat exchange body 40.

The first port portion 41 has a substantially block shape, and a first communication flow path 41f is formed inside the first port portion 41.

As shown in FIG. 4, the first communication flow path 41f includes a first main communication flow path 41m and a first sub communication flow path 41s independent of the first main communication flow path 41m.

The first pipe 42 consists of four flexible bellows pipes (first pipe body 42f second pipe body 42s, third pipe body 42t, and fourth pipe body 42fo). Each of the first pipe body 42f, the second pipe body 42s, the third pipe body 42t, and the fourth pipe body 42fo is made of polyamide.

As shown in FIG. 1, one end portion of the first pipe body 42f is attached to one end portion of the first main flow path 40m of the first heat exchange flow path 40f, and the first pipe body 42f and the first main flow path 40m communicate with each other. As shown in FIG. 4, another end portion of the first pipe body 42f is attached to one end portion of the first main communication flow path 41m of the first port portion 41, and the first pipe body 42f and the first main communication flow path 41m communicate with each other.

As shown in FIG. 1, one end portion of the second pipe body 42s is attached to another end portion of the first main flow path 40m of the first heat exchange flow path 40f, and the second pipe body 42s and the first main flow path 40m communicate with each other. As shown in FIG. 4, another end portion of the second pipe body 42s is attached to another end portion of the first main communication flow path 41m of the first port portion 41, and the second pipe body 42s and the first main communication flow path 41m communicate with each other.

As shown in FIG. 1, one end portion of the third pipe body 42t is attached to one end portion of the first sub flow path 40s of the first heat exchange flow path 40f, and the third pipe body 42t and the first sub flow path 40s communicate with each other. As shown in FIG. 4, another end portion of the third pipe body 42t is attached to one end portion of the first sub communication flow path 41s of the first port portion 41, and the third pipe body 42t and the first sub communication flow path 41s communicate with each other.

As shown in FIG. 1, one end portion of the fourth pipe body 42fo is attached to another end portion of the first sub flow path 40s of the first heat exchange flow path 40f, and the fourth pipe body 42fo and the first sub flow path 40s communicate with each other. As shown in FIG. 4, another end portion of the fourth pipe body 42fo is attached to another end portion of the first sub communication flow path 41s of the first port portion 41, and the fourth pipe body 42fo and the first sub communication flow path 41s communicate with each other.

Accordingly, the first main flow path 40m of the first heat exchange flow path 40f and the first main communication flow path 41m of the first port portion 41 are connected via the first pipe body 42f and the second pipe body 42s of the first pipe 42, and the first sub flow path 40s of the first heat exchange flow path 40f and the first sub communication flow path 41s of the first port portion 41 are connected via the third pipe body 42t and the fourth pipe body 42fo of the first pipe 42.

The second heat exchanger 5 includes a second heat exchange body 50, a second port portion 51, and a second pipe 52.

Similar to the first heat exchange body 40, the second heat exchange body 50 has a plate shape in which two aluminum sheets are stacked and welded to be integrated with each other. A second heat exchange flow path 50f is formed inside the second heat exchange body 50. The second heat exchange flow path 50f includes a second main flow path 50m and a second sub flow path 50s independent of the second main flow path 50m.

Similar to the first port portion 41, the second port portion 51 is made of aluminum, molded separately from the second heat exchange body 50, and welded to the second heat exchange body 50 to be integrated with the second heat exchange body 50.

Similar to the first port portion 41, the second port portion 51 has a substantially block shape, and a second communication flow path 51f is formed inside the second port portion 51. The second communication flow path 51f includes a second main communication flow path 51m and a second sub communication flow path 51s independent of the second main communication flow path 51m.

The second pipe 52 consists of four flexible bellows pipes (fifth pipe body 52fi, sixth pipe body 52si, seventh pipe body 52se, and eighth pipe body 52e). Each of the fifth pipe body 52fi, the sixth pipe body 52si, the seventh pipe body 52se, and the eighth pipe body 52e is made of polyamide.

As shown in FIG. 1, one end portion of the fifth pipe body 52fi is attached to one end portion of the second main flow path 50m of the second heat exchange flow path 50f, and the fifth pipe body 52fi and the second main flow path 50m communicate with each other. As shown in FIG. 4, another end portion of the fifth pipe body 52fi is attached to one end portion of the second main communication flow path 51m of the second port portion 51, and the fifth pipe body 52fi and the second main communication flow path 51m communicate with each other.

As shown in FIG. 1, one end portion of the sixth pipe body 52si is attached to another end portion of the second main flow path 50m of the second heat exchange flow path 50f, and the sixth pipe body 52si and the second main flow path 50m communicate with each other. As shown in FIG. 4, another end portion of the sixth pipe body 52si is attached to another end portion of the second main communication flow path 51m of the second port portion 51, and the sixth pipe body 52si and the second main communication flow path 51m communicate with each other.

As shown in FIG. 1, one end portion of the seventh pipe body 52se is attached to one end portion of the second sub flow path 50s of the second heat exchange flow path 50f, and the seventh pipe body 52se and the second sub flow path 50s communicate with each other. As shown in FIG. 4, another end portion of the seventh pipe body 52se is attached to one end portion of the second sub communication flow path 51s of the second port portion 51, and the seventh pipe body 52se and the second sub communication flow path 51s communicate with each other.

As shown in FIG. 1, one end portion of the eighth pipe body 52e is attached to another end portion of the second sub flow path 50s of the second heat exchange flow path 50f, and the eighth pipe body 52e and the second sub flow path 50s communicate with each other. As shown in FIG. 4, another end portion of the eighth pipe body 52e is attached to another end portion of the second sub communication flow path 51s of the second port portion 51, and the eighth pipe body 52e and the second sub communication flow path 51s communicate with each other.

Accordingly, the second main flow path 50m of the second heat exchange flow path 50f and the second main communication flow path 51m of the second port portion 51 are connected via the fifth pipe body 52fi and the sixth pipe body 52si of the second pipe 52, and the second sub flow path 50s of the second heat exchange flow path 50f and the second sub communication flow path 51s of the second port portion 51 are connected via the seventh pipe body 52se and the eighth pipe body 52e of the second pipe 52.

The assembly base 3 is made of a galvanized steel sheet, which is a type of metal material, and includes a box-shaped base body 30 having a substantially box shape and a base-side attachment portion 31 assembled to the box-shaped base body 30.

Among these, the base-side attachment portion 31 is produced by die casting and has a block shape. The first port portion 41 of the first heat exchanger 4 is assembled to the base-side attachment portion 31.

In the heat exchange device 1 and the heat exchange unit 2 of the embodiment, the assembly base 3 and the first heat exchanger 4 have a positioning structure for positioning each other. The first heat exchanger 4 and the second heat exchanger 5 also have a positioning structure for positioning each other.

Specifically, as shown in FIG. 4, the base-side attachment portion 31 of the assembly base 3 has pin-shaped guide portions 31g extending in the up-down direction, at an upper surface thereof.

The first heat exchanger 4 has guide counterparts 41g having a recessed groove shape corresponding to the above guide portions 31g, at the first port portion 41. The guide counterparts 41g extend in the up-down direction and are open on the lower surface of the first port portion 41.

As described later, the direction in which the guide portions 31g extend, that is, the up-down direction, coincides with the assembly direction of the assembly base 3 and the first heat exchanger 4 and the assembly direction of the first heat exchanger 4 and the second heat exchanger 5.

In addition, the first heat exchanger 4 has first engagement portions 41e having a projection shape, at the upper surface of the first port portion 41. The first engagement portions 41e extend in the up-down direction and have a tapered shape that narrows upward.

The second heat exchanger 5 has second engagement portions 51e having a recess shape corresponding to the above first engagement portions 41e, at the second port portion 51. The second engagement portions 51e have a substantially concave tapered shape extending in the up-down direction and are open on the lower surface of the second port portion 51.

The connection port 6 is made of polyphenylene sulfide and is molded separately from the first heat exchanger 4, the second heat exchanger 5, and the assembly base 3.

Hereinafter, the work of integrating the assembly base 3, the first heat exchanger 4, and the second heat exchanger 5 in the heat exchange device 1 and the heat exchange unit 2 of the embodiment will be described.

First, the first heat exchanger 4, the second heat exchanger 5, and the assembly base 3 described above are prepared in advance.

Then, the first heat exchanger 4 is assembled to the assembly base 3.

First, the first heat exchanger 4 is placed substantially on the front and upper side of the assembly base 3, and the first port portion 41 is positioned above the base-side attachment portion 31 of the assembly base 3. Thus, the guide portions 31g provided to the first port portion 41 face the guide counterparts 41g provided to the base-side attachment portion 31, from above.

As described above, each guide portion 31g has a pin shape extending in the up-down direction, and each guide counterpart 41g has a recessed groove shape extending in the up-down direction. Therefore, when the position of the first heat exchanger 4 is changed downward in this state, each guide portion 31g is inserted into the guide counterpart 41g, and the first heat exchanger 4 is positioned with respect to the assembly base 3.

Next, the second heat exchanger 5 is placed substantially on the upper side of the first heat exchanger 4, and the second port portion 51 is positioned above the first port portion 41. Thus, the second engagement portions 51e provided to the second port portion 51 face the first engagement portions 41e provided to the first port portion 41, from above.

As described above, each first engagement portion 41e has a tapered shape extending in the up-down direction, and each second engagement portion 51e has a mortar shape extending in the up-down direction. Therefore, when the position of the second heat exchanger 5 is changed downward in this state, each first engagement portion 41e is inserted into the second engagement portion 51e, and the second heat exchanger 5 is positioned with respect to the first heat exchanger 4.

At this time, the first communication flow path 41f provided in the first port portion 41 of the first heat exchanger 4 and the second communication flow path 51f provided in the second port portion 51 of the second heat exchanger 5 are also positioned with respect to each other. When each second engagement portion 51e and each first engagement portion 41e are brought into engagement with each other in this state, the first port portion 41 and the second port portion 51 are assembled together. Accordingly, the first heat exchanger 4 and the second heat exchanger 5 are integrated, the first main flow path 40m and the second main flow path 50m communicate with each other, and the first sub flow path 40s and the second sub flow path 50s communicate with each other. That is, at this time, the first heat exchange flow path 40f and the second heat exchange flow path 50f communicate with each other.

O-rings (not shown) are arranged at the boundary between the first main flow path 40m and the second main flow path 50m and at the boundary between the first sub flow path 40s and the second sub flow path 50s, respectively. Accordingly, the first heat exchange flow path 40f and the second heat exchange flow path 50f are partitioned in a liquid-tight manner from the outside environment.

Thus, the first heat exchanger 4 and the second heat exchanger 5 are assembled to each other.

Meanwhile, the heat exchange device 1 and the heat exchange unit 2 of the embodiment further include the connection port 6 in addition to the first heat exchanger 4, the second heat exchanger 5, and the assembly base 3.

As shown in FIG. 1, the connection port 6 has two port pipe portions 60 having a tubular shape and extending in a direction crossing the up-down direction, specifically in the front-rear direction. A connection flow path 60f is formed inside each port pipe portion 60.

The base-side attachment portion 31 is provided with two connection holes 31c having a through hole shape corresponding to the port pipe portions 60, and each connection hole 31c faces an end portion of the first communication flow path 41f provided in the first port portion 41.

Therefore, when one end portion of each port pipe portion 60 is inserted into the corresponding connection hole 31c, the first port portion 41 and the assembly base 3 are integrated by the connection port 6, and further, the first communication flow path 41f of the first port portion 41 and the connection flow path 60f communicate with each other.

For reference, external devices such as a pump and a liquid tank for circulating the heat exchange medium are connected to other end portions of the port pipe portions 60 of the connection port 6.

According to the heat exchange device 1 and the heat exchange unit 2 of the embodiment, as described above, by simply sequentially assembling the first heat exchanger 4 and the second heat exchanger 5 to the assembly base 3, a flow path, for the heat exchange medium, that provides communication between the heat exchangers is formed. Thus, the work of integrating a plurality of heat exchangers, that is, the first heat exchanger 4 and the second heat exchanger 5, does not require a large space, and this work is allowed to be performed in a relatively small space.

Moreover, since the first heat exchange flow path 40f and the second heat exchange flow path 50f are caused to communicate with each other through a very simple assembly process as described above, even when the assembly work for the first heat exchanger 4 and the second heat exchanger 5 is performed by, for example, a robot, this assembly work is allowed to be performed with sufficient assembly accuracy.

Although the present disclosure has been described above, the present disclosure is not limited to the above-described embodiment, etc., components described in the embodiment, etc., may be optionally extracted and combined to carry out the present disclosure, and various changes may be made without departing from the gist of the present disclosure.

In addition, the specification of the present disclosure discloses not only the citation relationship between the claims as originally filed, but also the technical concept obtained by combining the matters recited in each claim as appropriate.

1. A heat exchange device comprising an assembly base and a heat exchange unit assembled to the assembly base, wherein
the heat exchange unit includes:
a first heat exchanger including a first heat exchange body having a first heat exchange flow path, a first port portion having a first communication flow path and integrated with the first heat exchange body, and a first pipe providing communication between the first heat exchange flow path and the first communication flow path, the first heat exchanger being assembled to the assembly base; and
a second heat exchanger including a second heat exchange body having a second heat exchange flow path, a second port portion having a second communication flow path and integrated with the second heat exchange body, and a second pipe providing communication between the second heat exchange flow path and the second communication flow path, the second heat exchanger being assembled to the first heat exchanger, and
when the first port portion and the second port portion are assembled together, the first heat exchanger and the second heat exchanger are integrated, and the first heat exchange flow path and the second heat exchange flow path communicate with each other.

2. The heat exchange device according to claim 1, wherein
the first heat exchange flow path includes a first main flow path and a first sub flow path independent of the first main flow path,
the second heat exchange flow path includes a second main flow path and a second sub flow path independent of the second main flow path, and
when the second port portion is assembled to the first port portion, the first main flow path and the second main flow path communicate with each other, and the first sub flow path and the second sub flow path communicate with each other.

3. The heat exchange device according to claim 1, wherein
the assembly base has a guide portion having a projection shape and extending in an assembly direction of the first heat exchanger with respect to the assembly base, at a base-side attachment portion to which the first heat exchanger is assembled,
the first heat exchanger has a guide counterpart which has a recess shape and extends in the assembly direction and into which the guide portion is inserted, and a first engagement portion having a projection shape and extending in the assembly direction, at the first port portion,
the second heat exchanger has a second engagement portion which has a recess shape and extends in the assembly direction and which is configured to be engaged with the first engagement portion, at the second port portion,
when a position of the first heat exchanger is changed toward the assembly base in the assembly direction, the guide portion is inserted into the guide counterpart, and the first heat exchanger is positioned with respect to the assembly base, and
when a position of the second heat exchanger is changed toward the first heat exchanger in the assembly direction, the second engagement portion and the first engagement portion are brought into engagement with each other, the first port portion and the second port portion are assembled together, and the second heat exchanger is positioned with respect to the first heat exchanger.

4. The heat exchange device according to claim 3, wherein
after the first port portion and the second port portion are assembled together and the second heat exchanger is positioned with respect to the first heat exchanger,
the assembly base and the first heat exchanger are fixed to each other when a connection port having a connection flow path is inserted from the base-side attachment portion toward the first port portion and the first heat exchange flow path and the connection flow path are caused to communicate with each other.

5. The heat exchange device according to claim 1, wherein the first pipe and the second pipe are bellows pipes.

6. A heat exchange unit configured to be assembled to an assembly base, the heat exchange unit comprising:
a first heat exchanger including a first heat exchange body having a first heat exchange flow path, a first port portion having a first communication flow path and integrated with the first heat exchange body, and a first pipe providing communication between the first heat exchange flow path and the first communication flow path, the first heat exchanger being assembled to the assembly base; and
a second heat exchanger including a second heat exchange body having a second heat exchange flow path, a second port portion having a second communication flow path and integrated with the second heat exchange body, and a second pipe providing communication between the second heat exchange flow path and the second communication flow path, the second heat exchanger being assembled to the first heat exchanger, wherein
when the first port portion and the second port portion are assembled together, the first heat exchanger and the second heat exchanger are integrated, and the first heat exchange flow path and the second heat exchange flow path communicate with each other.
